(19) United States
(12) Patent Application Publication
(10) Pub. No.: US 2025/0199618 A1
(43) Pub. Date: Jun. 19, 2025

(54) HANDHELD HAPTIC DEVICE FOR REALISTIC POWER TOOL FEEDBACK IN VR-BASED MANUFACTURING TRAINING

(71) Applicant: Purdue Research Foundation, West Lafayette, IN (US)

(72) Inventors: Karthik Ramani, West Lafayette, IN (US); Mayank Harendra Patel, West Lafayette, IN (US); Asim Unmesh, Indianapolis, IN (US)

(21) Appl. No.: 18/986,870

(22) Filed: Dec. 19, 2024

Related U.S. Application Data
(60) Provisional application No. 63/612,068, filed on Dec. 19, 2023.

(51) Int. Cl. G06F 3/01; G06F 3/0346; G06T 7/70; G06V 10/70

(52) U.S. Cl. CPC G06F 3/016; G06F 3/011; G06F 3/0346; G06T 7/70; G06V 10/70; G06T 2200/24

(57) ABSTRACT

A handheld haptic device and method for providing haptic feedback during a virtual interaction with a virtual power tool is disclosed. The handheld haptic device has actuators configured to generate haptic vibrations. A haptic vibration database is provided having a plurality of haptic vibration profiles that are selected as a function of the or more state parameters including an operating speed of the virtual power tool, an orientation of the handheld haptic device, and a material of a virtual workpiece. The system leverages the haptic vibration database to generate authentic haptic vibrations with the handheld haptic device, depending on the state parameters.

This application claims the benefit of priority of U.S. provisional application Ser. No. 63/612,068, filed on Dec. 19, 2023 the disclosure of which is herein incorporated by reference in its entirety.

### GOVERNMENT LICENSE RIGHTS

This invention was made with government support under contract number DUE1839971 awarded by the National Science Foundation. The government has certain rights in the invention.

### FIELD

The system and method disclosed in this document relates to haptic devices and, more particularly, to a handheld haptic device for power tool feedback in augmented-reality or virtual-reality based manufacturing training.

### BACKGROUND

Unless otherwise indicated herein, the materials described in this section are not admitted to be the prior art by inclusion in this section.

With the surge in Virtual Reality (VR) applications, industries are progressively adopting novel methods for skills training. VR-based skill training offers a distinct advantage by enabling safe simulations of potentially hazardous or costly training scenarios that would be impractical in a physical setting. Particularly effective for tasks requiring hands-on experience, VR allows learners to practice intricate and challenging tasks within a secure virtual environment. This repetitive practice not only enhances skill acquisition but also facilitates the development of muscle memory. During consultations with industry experts, it was uncovered that users often faced difficulty transitioning to real-world scenarios, specifically for power tool applications. This challenge arises from the substantial weight of power tools and the vibrational feedback they generate during operation. Users heavily rely on haptic feedback, encompassing object interactions, forces, hand pressure, and cutaneous cues like vibrations and weight perception, to facilitate the acquisition of motor skills. While numerous haptic devices have been developed so far, they often lack the intricate rendering required for comprehensive kinesthetic and cutaneous feedback. Particularly, haptic devices fail to address the high-g vibrations, weight, and balance, crucial for power tool training in VR.

The manufacturing sector has yet to fully embrace motor skills training through immersive VR, in part due to the lack of specialized haptic devices tailored to this domain. The manufacturing industry heavily relies on the utilization of power tools to facilitate a wide range of processes. This assortment of power tools encompasses, for example, rivet guns, drill guns, electric screwdrivers, impact wrenches, side grinders, portable bandsaws, chainsaws, jigsaws, power sanders, and nail guns. However, current haptic devices are incapable of effectively integrating these diverse tools into a VR environment for skill training because they are incapable of delivering authentic haptic feedback specific to each tool.

Thus, what is needed is a comprehensive haptic device that provides ungrounded feedback that is both compact and portable, effectively replicating the vibratory feedback associated with various power tools, as well as capturing their weight and inertia.

### SUMMARY

A method for providing haptic feedback for a virtual interaction using a handheld haptic device is disclosed. The virtual interaction includes operating a virtual power tool. The method comprises storing, in a memory, a plurality of haptic vibration profiles. Each respective haptic vibration profile is associated with different respective values of at least one state parameter. The method further comprises determining current values of the at least one state parameter as a user holds the handheld haptic device. The method further comprises selecting, from the plurality of haptic vibration profiles, a selected haptic vibration profile based on the current values of the at least one state parameter. The method further comprises operating, during the virtual interaction, at least one actuator of the handheld haptic device to provide the haptic feedback according to the selected haptic vibration profile.

A system for providing haptic feedback for a virtual interaction is disclosed. The virtual interaction includes operating a virtual power tool. The system comprises an augmented reality or virtual reality device. The augmented reality or virtual reality device includes a processor. The augmented reality or virtual reality device includes a memory that stores a plurality of haptic vibration profiles. Each respective haptic vibration profile is associated with different respective values of at least one state parameter. The augmented reality or virtual reality device includes a display screen configured to display an augmented reality or virtual reality graphical user interface including a graphical representation of the virtual interaction. The system further comprises a handheld haptic device having at least one actuator arranged within a housing. The processor of the augmented reality or virtual reality device is configured to determine current values of the at least one state parameter as a user holds the handheld haptic device. The processor of the augmented reality or virtual reality device is further configured to select, from the plurality of haptic vibration profiles, a selected haptic vibration profile based on the current values of the at least one state parameter. The processor of the augmented reality or virtual reality device is further configured to operate, during the virtual interaction, the at least one actuator of the handheld haptic device to provide the haptic feedback according to the selected haptic vibration profile.

### BRIEF DESCRIPTION OF THE DRAWINGS

The foregoing aspects and other features of the handheld haptic device are explained in the following description, taken in connection with the accompanying drawings.

FIG. 1 shows a flow diagram for the haptic rendering workflow in which a handheld haptic device is operated to provide haptic and vibrotactile feedback.

FIG. 2 shows an X-Y-Z coordinate frame of the handheld haptic device.

FIG. 3 shows an exploded view of the detachable weight mountings of the handheld haptic device.

FIG. 4 shows internal components of the handheld haptic device.

FIG. 5 shows exemplary components of an AR/VR training system that utilizes the handheld haptic device.

FIG. 6 shows a flowchart for a vibration measurement pipeline used to generate the haptic vibration database.

FIG. 7 shows a measurement setup for collecting acceleration data while drilling into a workpiece.

FIG. 8 shows a graph representing power drill acceleration as measured from the accelerometer over time during operation of the power drill machine.

FIG. 9 shows several amplitude vs time graphs for vibrations generated while drilling different materials using a power drill as measured from the accelerometer.

FIG. 10 shows exemplary pseudocode for training a machine learning model for mapping a haptic vibration profile to haptic control parameters for the handheld haptic device.

FIG. 11 shows a logical flow diagram for a method for providing haptic feedback for a virtual interaction using a handheld haptic device.

FIG. 12 shows an exemplary AR/VR graphical user interface.

FIG. 13 shows a user holding the handheld haptic device.

### DETAILED DESCRIPTION

To promote an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview

In virtual reality (VR) or augmented reality (AR) based manufacturing training employing handheld controllers for power tool operation, users consistently encounter a glaring impediment: the conspicuous absence of realistic haptic and vibrotactile feedback. This critical shortfall significantly hinders the seamless transfer of acquired skills from the virtual realm to the real-world application, posing a substantial challenge to effective training. To surmount this obstacle, this disclosure introduces a system for providing realistic feedback that includes a handheld haptic device 110 that enables immersive VR and AR skills training for power tools. The handheld haptic device 110 advantageously provides active feedback using actuators, as well as passive feedback in the form of weight perception and mass distribution using detachable weights. In contrast with existing systems, the actuators of the handheld haptic device 110 advantageously capable of delivering high-g and multi-harmonic vibrotactile feedback. These features empower users to better develop muscle memory and refine their power tool operation skills more effectively.

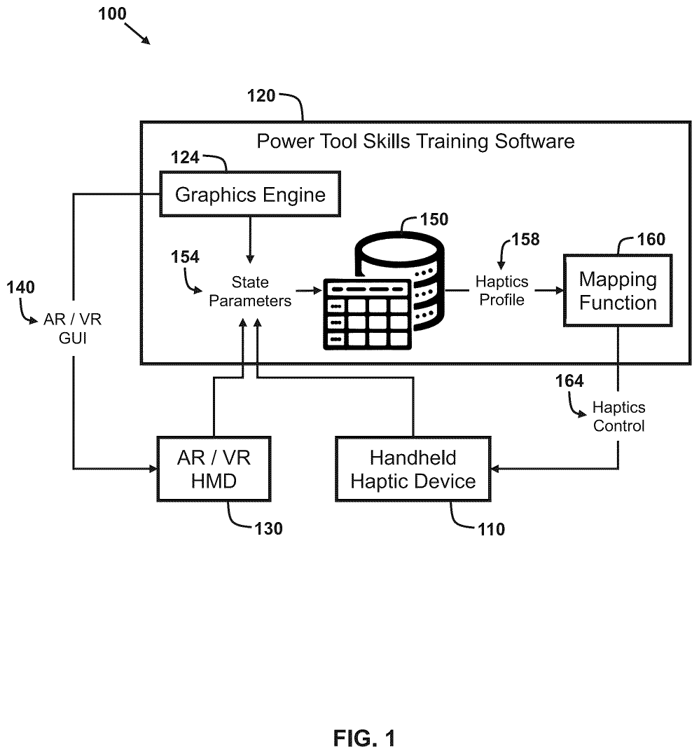

FIG. 1 shows a flow diagram for the haptic rendering workflow 100 in which a handheld haptic device 110 is operated to provide haptic and vibrotactile feedback. Particularly, power tool skills training software 120 is provided that enables a user to develop power tool-related skills in a virtual environment using a virtual power tool. The power tool skills training software 120 advantageously incorporates a graphics engine 124 configured to render an augmented reality (AR) or virtual reality (VR) graphical user interface 140, which is displayed to the user via an AR or VR head-mounted display 130 (AR/VR HMD), for providing the virtual environment and enabling virtual interactions using the virtual power tool. The handheld haptic device 110 is held by the user as a physical proxy for the virtual power tool while performing virtual interactions using the virtual power tool in the virtual environment. The power tool skills training software 120 advantageously operates actuators of the handheld haptic device 110 to provide appropriate haptic and vibrotactile feedback that realistically simulates the experience of holding and operating the physical power tool that corresponds to the virtual power tool. Additionally, the handheld haptic device 110 is advantageously configurable with detachable weights that provide passive feedback by altering the center of gravity of the handheld haptic device 110 to mimic that of the physical power tool that is represented by the virtual power tool.

To provide realistic haptic and vibrotactile feedback, the haptic rendering workflow 100 leverages a haptic vibration database 150 that stores a plurality of different haptic vibration profiles for different system states. Particularly, each different haptic vibration profile is associated with a particular set of state parameters including, for example, the operating speed of the virtual power tool, the orientation of the virtual power tool, the and the material of a workpiece being worked on by the virtual power tool. Based on current values of such state parameters 154, a suitable haptic vibration profile 158 is selected from the haptic vibration database 150. A mapping function 160 maps the selected haptic vibration profile 158 to haptics control parameters 164 configured to operate actuators of the handheld haptic device 110 to accurately reproduce the selected haptic vibration profile 158 in the handheld haptic device 110.

### Handheld Haptic Device

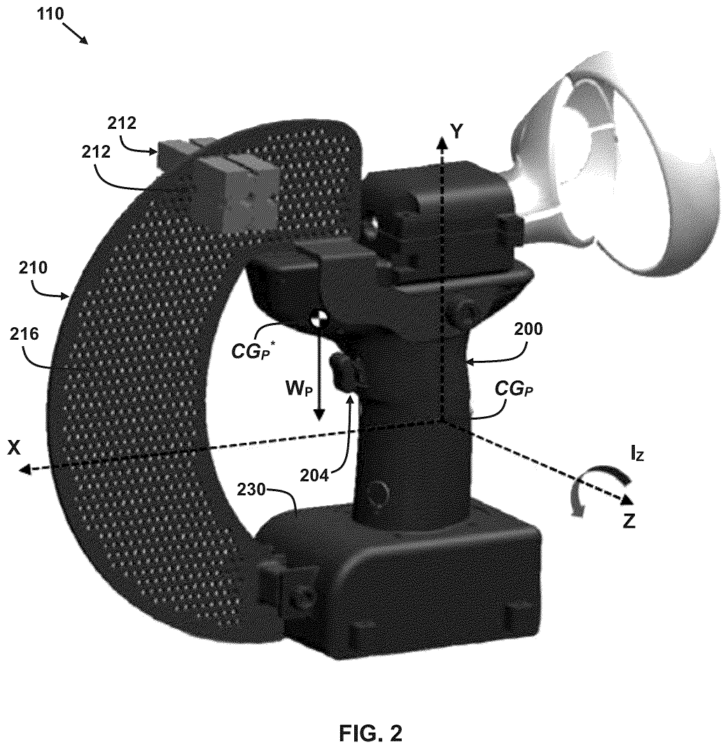

FIGS. 2-4 show an exemplary embodiment of the handheld haptic device 110. It should be appreciated that developing a comprehensive haptic device presents a challenge in creating ungrounded feedback that is both compact and portable, effectively replicating the vibratory feedback associated with various power tools, as well as capturing their weight and inertia. The distinct physical attributes of each tool, defined by its shape, weight, and operational principles, further compound this challenge. To these ends, the handheld haptic device 110 is an ungrounded handheld device with the capacity to offer both kinesthetic and cutaneous feedback for various tools, while also accommodating different operational parameters unique to each tool. Kinesthetic feedback includes object configuration in terms of mass distribution, forces, and hand pressure, achieved through a uniform tool balance approach.

As can be seen, a housing 230 of the handheld haptic device 110 is shaped to incorporate a handle 200. The handle 200 is configured to be grasped by a user and, in the illustrated embodiment, has a form that is essentially similar to the handle of a conventional electric drill. The handle 200 has a trigger 204, which acts as a physical input device to receive control inputs from the user during power tool skills training. The body of the handheld haptic device 110 further includes a support structure, referred to herein as a weight shift linkage 210, which extends from the handle 200 and is configured to detachably connect with one or more detachable weights 212. The detachable weights 212 are provided to simulate the mass distribution of a corresponding physical power tool. This approach ensures that the handheld haptic device 110 replicates a similar weight distribution and handling experience across different tools, promoting a cohesive and familiar user interaction with each corresponding physical power tool.

FIG. 2 shows an X-Y-Z coordinate frame of the handheld haptic device 110. When designing the handheld haptic device 110, the following considerations were taken into account: Firstly, the center of gravity plays a pivotal role in passive haptic perception, and replicating its position in virtual scenarios closely mimics the sensation of holding real tools. Secondly, the overall mass of a power tool significantly impacts the forces experienced by the user's hand such that accurately reproducing this mass results in more precise force feedback. Thirdly, many power tools exhibit symmetry across the X-Y plane, such that their center of gravity typically lies within this plane and mass is typically evenly distributed on both sides.

In the illustrated X-Y-Z coordinate frame, a center of the handle 200 serves as the origin, while the Y-axis aligns parallel to the handle 200, and the X-axis extends horizontally, forming a right-handed coordinate system with the Y and Z axes. Without the detachable weights 212, the handheld haptic device 110 the center of gravity (CG_{P}) located close to the center of the handle 200, is designated as the origin (CG_{P}=0,0). These characteristics enable the handheld haptic device 110 to replicate a wide range of power tools in terms of total weight and center of gravity relative to the handle 200. In the illustrated example, the detachable weights 212 are mounted on an upper portion of the weight shift linkage 210, which shifts the center of gravity relative to the handle 200 in a forward and upward direction, thereby establishing modified center of gravity (CG_{P}*) and a total weight (W_{P}) that is designed to mimic that of a corresponding physical power tool.

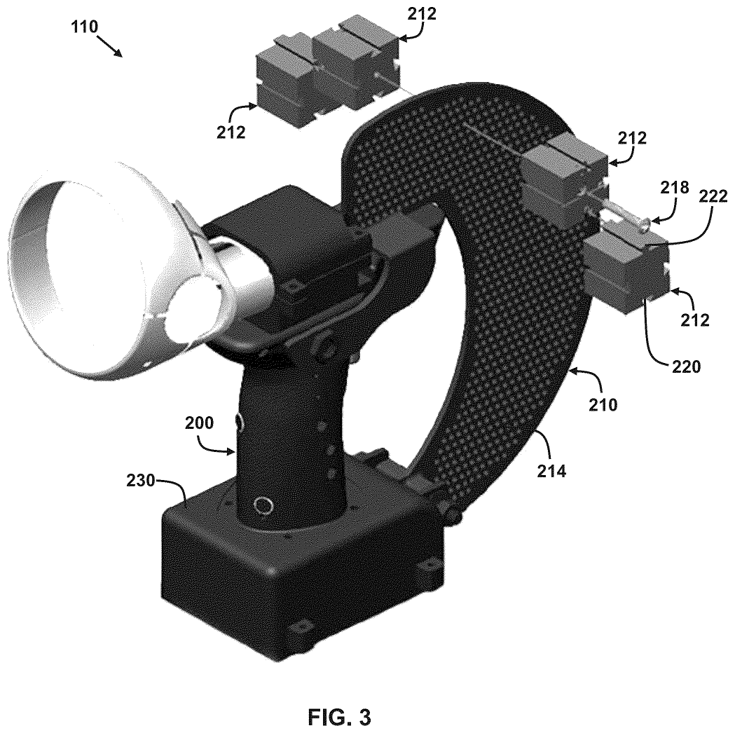

FIG. 3 shows an exploded view of the detachable weight mountings of the handheld haptic device 110. As can be seen, the weight shift linkage 210 has a substantially planar first surface 214 and a substantially planar second surface 216 (shown in FIG. 2) that is opposite the first surface 214. The first surface 214 and the second surface 216 are configured to detachably connect with the detachable weights 212 on either side of the weight shift linkage 210. To these ends, the body of the weight shift linkage 210 defines a plurality of apertures (holes) between the first surface 214 and the second surface 216. The detachable weights 212 are configured to mount to the first surface 214 and the second surface 216 by connecting to the apertures thereof. In the illustrated example, a bolt 218 is used to secure the detachable weights 212 to one of the apertures extending through the weight shift linkage 210. In some cases, the bolt 218 is driven through an aperture of the weight shift linkage 210 to connect with one of the detachable weights 212 on an opposite side of the weight shift linkage 210.

Users can easily attach symmetrical auxiliary weights to the X-Y plane. In at least some embodiments, the detachable weights 212 are provided in pairs having a same mass. The detachable weights 212 mount onto the apertures at any position on the weight shift linkage 210 to achieve a precisely aligned center of gravity. In one embodiment, the detachable weights 212 are designed as precisely CNC machined 1″×1″×1″ steel cubes weighing, for example, 120 grams each. In the illustrated example, the body of each detachable weight 212 defines an aperture (hole) that extends through a body of the detachable weight 212 that is configured to receive the bolt 218. Additionally, the body of each detachable weight 212 defines dovetail sockets 220 on three sides and a dovetail pin 222 on the fourth side for interlocking connections to other detachable weights 212, ensuring a secure fit and attachment.

By arranging the detachable weights 212 strategically, users can achieve both the desired total weight and balance, closely matching those of real power tools. This weight-balancing mechanism significantly enhances haptic feedback realism, elevating the authenticity of the virtual tool-handling experience. In general, strategic arrangement includes installing the detachable weights 212 at locations that align the center of gravity of the handheld haptic device 110 relative to or in relation to a center of the handle 200 with the center of gravity of a corresponding physical power tool relative to or in relation to a center of a handle of the physical power tool. This alignment is beneficial for providing users with an immersive sensation of holding the physical power tool.

Determining the precise positions for the detachable weights 212 is a multi-faceted challenge that relies on empirical insights and technical accuracy. Two methods might be adopted for determining where to place the detachable weights 212. Firstly, the center of gravity of a corresponding physical power tool relative to or in relation to a center of a handle of the physical power tool can be accurately determined using a CAD model for the physical power tool. Alternatively, when CAD models are unavailable, the so-called ‘string method’ can be used to estimate the center of gravity. The center of gravity of an object can be estimated using the string method by suspending it from a point and allowing it to hang freely, aligning with the force of gravity. A plumb line is then used to draw a vertical line from the suspension point, and the process is repeated by suspending the object from another point, with the intersection of the two lines marking the center of gravity.

Unlike passive feedback, which remains constant for a particular physical power tool, the vibration generated by a physical power tool varies based on how the power tool is being used. In particular, the haptic vibration of a physical power tool depends on an operating speed of the power tool, a material of the workpiece being operated on, a size of the power tool, and an orientation of the power tool.

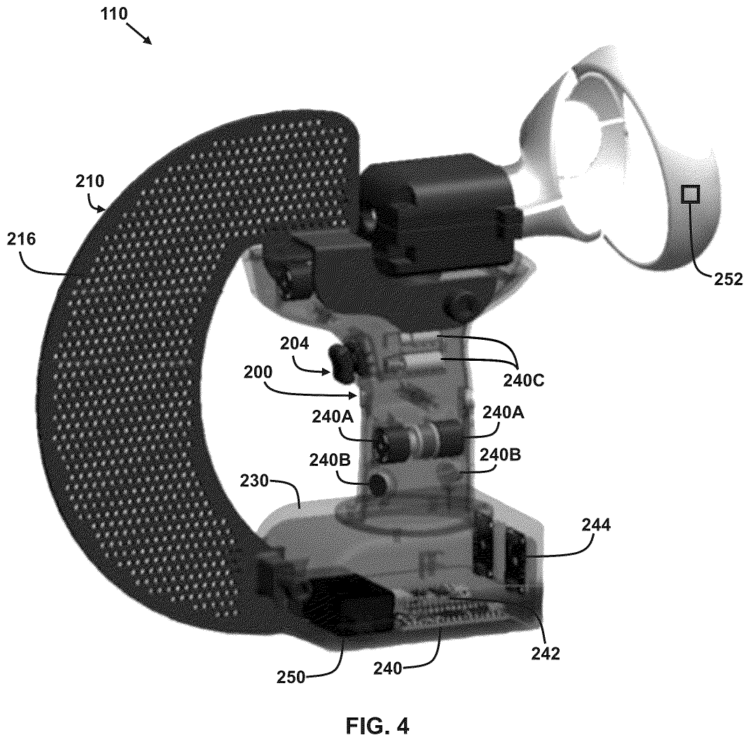

FIG. 4 shows internal components of the handheld haptic device 110. Particularly, within a housing 230, the handheld haptic device 110 includes one or more haptic actuators 240A-C positioned such that it can provide a haptic sensation for all the operations of any handheld power tool. The haptic actuators 240A-C include one or more transducers configured to generate perceptible haptic vibrations or the like for the user. The haptic actuators 240A-C may include, for example, Linear Magnetic Ram (LMR) actuators 240A, Linear Resonant Actuator (LRA) motors 240B, and/or Eccentric Rotating Mass (ERM) motors 240C. This configuration enables the handheld haptic device 110 to simulate a comprehensive spectrum of tactile feedback, realistically replicating the sensations associated with various handheld power tool operations. A deliberate arrangement of these actuators guarantees that the handheld haptic device 110 can effectively deliver haptic feedback for a wide range of tasks. The placement of actuators and components in the handheld haptic device 110 was strategically designed for optimal feedback transmission and center of gravity balance.

In one embodiment, the handheld haptic device 110 is equipped with two LMR actuators 240A. The LMR actuators 240A are capable of producing a wide range of frequencies by modulating the PWM control signals from a motor driver 264. Particularly, the frequency, intensity, and duty cycle of the PWM control signals can be modulated to generate various vibrotactile feedback sensations. In addition to generating vibrations, the LMR actuators 240A can deliver impulse haptic feedback by rapidly actuating the ram on a mechanical fixture. The intensity of the impulse haptic feedback can also be controlled using the PWM control signals. In one embodiment, the two LMR actuators 240A are connected in parallel, enabling the generation of a broad spectrum of vibrations to simulate drilling motions. Furthermore, the placement of the LMR actuators 240A is strategic. A first of the LMR actuators 240A is located at the center of the handle 200 to transmit both small and large vibrations effectively, minimizing loss and ensuring maximum feedback transfer. The first of the LMR actuators 240A can thus produce a slight impulse moment near the handle 200 to transfer small amplitude vibrations effectively. Simultaneously, the second of the LMR actuators 240A is positioned on the top of the device and focuses on high-g feedback and generating secondary and tertiary harmonics, ensuring perceptible harmonics at the handle 200. The second of the LMR actuators 240A can thus produce high-amplitude, short-duration vibrational feedback for impact drilling and riveting actions.

In one embodiment, the handheld haptic device 110 is equipped with two LRA motors 240B. The LRA motors 240B are driven through PWM feedback control from the motor driver 264. By adjusting the supplied voltage and current, the motor driver 264 can finely control the intensity of the haptic sensations they produce. The LRA motors 240B excel in generating delicate haptic experiences that typically span a frequency range of 25 to 150 Hz. The LRA motors 240B are also capable of vibrating with subtle amplitudes, rendering them particularly suitable for replicating the vibrations arising from power tool operations conducted at low speeds. Strategically positioned on the periphery of the handle 200 to avoid mechanical losses or damping effects, the LRA motors 240B effectively transfer these slight vibrations to the user's hand, creating an immersive haptic experience through subtle, low-intensity feedback.

Finally, in one embodiment, the handheld haptic device 110 is equipped with two ERM motors 240C. Most power tools are equipped with motors that supply torque and speed to the cutting surface. When power tools are improperly oriented in relation to the cutting surface and tool edge, they generate sinusoidal vibrations with significant amplitude. Emulating these vibrations effectively can be achieved using the ERM motors 240C, since the frequency of ERM vibration can be controlled by adjusting the voltage provided from the motor driver 264. Despite certain limitations compared to voice coil motors or LRA motors, such as their slow response, loud noise, and large inertia, the ERM motors 240C present an advantageous choice for this application. This is because characteristics like loud noise, large inertia, and slow response are inherent to power tools. The pair of ERM actuators 240C are placed near the center of the handle 200 for direct and efficient transfer to the user's hand. The ERM motors 240C are capable of generating both low and high g-force vibrations, which is advantageous for providing haptic feedback akin to the vibrations encountered during incorrect power tool operations. In one embodiment, the two ERM motors 240C are each capable of producing a maximum acceleration equivalent to 2.6 g and 7 g, respectively.

In some embodiments, the handheld haptic device 110 further includes a battery 250 or other power source (not shown) configured to power the various components within the handheld haptic device 110. In one embodiment, the battery 250 of the handheld haptic device 110 is a rechargeable battery configured to be charged when the handheld haptic device 110 is connected to a battery charger configured for use with the handheld haptic device 110.

In some embodiments, the handheld haptic device 110 further includes one or more sensors 252. The sensors 252 may include one or more accelerometers configured to measure linear accelerations of the handheld haptic device 110 along one or more axes (e.g., roll, pitch, and yaw axes) and/or one or more gyroscopic sensors configured to measure rotational rates of the handheld haptic device 110 along one or more axes (e.g., roll, pitch, and yaw axes).

With continued reference to FIG. 4, the handheld haptic device 110 further includes a controller 260. The controller 260 is configured to generate control commands for operating the haptic actuators 240A-C, e.g., using the I2C communication protocol and software APIs. The controller 260 comprises at least one processor with associated memory (not shown) which stores program instructions that, when executed by the processor, enable the controller 260 and/or the handheld haptic device 110 to perform various operations described elsewhere herein. The memory of the controller 260 may be of any type of device capable of storing information accessible by the processor, such as a memory card, ROM, RAM, flash memory, or any of various other computer-readable medium serving as data storage devices, as will be recognized by those of ordinary skill in the art. Additionally, it will be recognized by those of ordinary skill in the art that a “processor” includes any hardware system, hardware mechanism or hardware component that processes data, signals or other information. Thus, the controller 260 may include a system with a central processing unit, graphics processing units, multiple processing units, dedicated circuitry for achieving functionality, programmable logic, or other processing systems. The controller 260 is configured to communicate with other components of the handheld haptic device 110 via one or more connections, data busses, or the like.

The motor driver 264 is configured to receive the control commands from the controller 260 and to generate control signals (e.g., PWM control signals) configured to operate the haptic actuators 240A-C based on the control commands. The motor driver 264 controls the electrical current, voltage, and frequency sent to the haptic actuators 240A-C, allowing for precise manipulation of haptic or vibrotactile feedback generated by the handheld haptic device 110.

The handheld haptic device 110 further includes a communications module 262 having one or more transceivers, modems, or other communication devices configured to enable communications with various other devices, at least including a processing system that operates the AR/VR HMD 130 (e.g., a computer). Particularly, the communications module 262 may comprises a Wi-Fi module. The Wi-Fi module is configured to enable communication with a Wi-Fi network and/or Wi-Fi router (not shown) and includes at least one transceiver with a corresponding antenna, as well as any processors, memories, oscillators, or other hardware conventionally included in a Wi-Fi module. It will be appreciated, however, that other communication technologies, such as Bluetooth, Z-Wave, Zigbee, or any other radio frequency-based communication technology or wired communication technology can be used to enable data communications between devices in the system. The control hardware, including the controller 260, the communications module 262, and the motor driver 264, are positioned at the bottom of the device to mimic a real power tool's battery placement and balance the CG.

### Exemplary AR/VR Training System

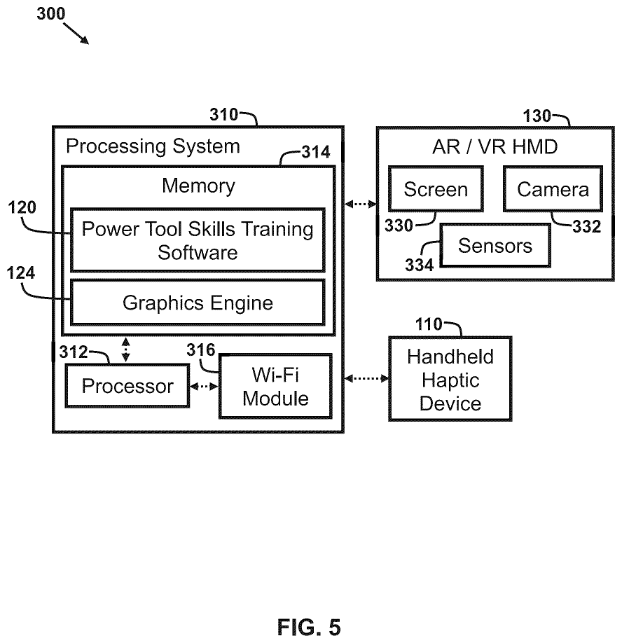

FIG. 5 shows exemplary components of an AR/VR training system 300 that utilizes the handheld haptic device 110. It will be appreciated that the components of the AR/VR training system 300 shown and described are merely exemplary and that the AR/VR training system 300 may comprise any alternative configuration. Moreover, in the illustration of FIG. 5, only a single AR/VR HMD 130 is shown. However, in practice, the AR/VR training system 300 may include one or multiple AR/VR HMDs.

In the illustrated exemplary embodiment, the AR/VR training system 300 includes a processing system 310, the AR/VR HMD 130 (e.g., Microsoft's HoloLens, Oculus Rift, or Oculus Quest), and the handheld haptic device 110. In some embodiments, the processing system 310 may comprise a discrete computer that is configured to communicate with the at least one handheld haptic device 110, and the AR/VR HMD 130 via one or more wired or wireless connections. However, in alternative embodiments, the processing system 310 is integrated with the AR/VR HMD 130.

In the illustrated exemplary embodiment, the processing system 310 comprises a processor 312 and a memory 314. The memory 314 is configured to store data and program instructions that, when executed by the processor 312, enable the AR/VR training system 300 to perform various operations described herein. The memory 314 may be of any type of device capable of storing information accessible by the processor 312, such as a memory card, ROM, RAM, hard drives, discs, flash memory, or any of various other computer-readable medium serving as data storage devices, as will be recognized by those of ordinary skill in the art. Additionally, it will be recognized by those of ordinary skill in the art that a “processor” includes any hardware system, hardware mechanism, or hardware component that processes data, signals, or other information. The processor 312 may include a system with a central processing unit, graphics processing units, multiple processing units, dedicated circuitry for achieving functionality, programmable logic, or other processing systems.

The processing system 310 further comprises one or more transceivers, modems, or other communication devices configured to enable communications with various other devices, at least including AR/VR HMD 130 and the handheld haptic device 110. Particularly, in the illustrated embodiment, the processing system 310 comprises a Wi-Fi module 316. The Wi-Fi module 316 is configured to enable communication with a Wi-Fi network and/or Wi-Fi router (not shown) and includes at least one transceiver with a corresponding antenna, as well as any processors, memories, oscillators, or other hardware conventionally included in a Wi-Fi module. It will be appreciated, however, that other communication technologies, such as Bluetooth, Z-Wave, Zigbee, or any other radio frequency-based communication technology or wired communication technology can be used to enable data communications between devices in the system.

The AR/VR HMD 130 is in the form of a VR, AR, or mixed reality (MR) headset, generally comprising a display screen 330. The AR/VR HMD 130 may also comprise a camera 332 for the purpose of object tracking and mapping. The camera 332 may be an integrated or attached camera and is configured to capture a plurality of images of the environment as the AR/VR HMD 130 is moved through the environment by the user. The camera 332 is configured to generate image frames of the environment, each of which comprises a two-dimensional array of pixels. Each pixel has corresponding photometric information (intensity, color, and/or brightness). In some embodiments, the camera 332 is configured to generate RGB-D images in which each pixel has corresponding photometric information and geometric information (depth and/or distance). In such embodiments, the camera 332 may, for example, take the form of two RGB cameras configured to capture stereoscopic images, from which depth and/or distance information can be derived, or an RGB camera with an associated IR camera configured to provide depth and/or distance information.

The display screen 330 may comprise any of various known types of displays, such as LCD or OLED screens. In at least one embodiment, the display screen 330 is a transparent screen, through which a user can view the outside world, on which certain graphical elements are superimposed onto the user's view of the outside world. In the case of a non-transparent display screen 330, the graphical elements may be superimposed on real-time images/video captured by the camera 332. In further embodiments, the display screen 330 may comprise a touch screen configured to receive touch inputs from a user.

In some embodiments, the AR/VR HMD 130 may further comprise a variety of sensors 334. In some embodiments, the sensors 334 include sensors configured to measure one or more accelerations and/or rotational rates of the AR/VR HMD 130. In one embodiment, the sensors 334 comprises one or more accelerometers configured to measure linear accelerations of the AR/VR HMD 130 along one or more axes (e.g., roll, pitch, and yaw axes) and/or one or more gyroscopic sensors configured to measure rotational rates of the AR/VR HMD 130 along one or more axes (e.g., roll, pitch, and yaw axes). In some embodiments, the sensors 334 may include inside-out motion tracking sensors configured to track human body motion of the user within the environment, in particular positions and movements of the head and hands of the user.

The AR/VR HMD 130 may also include a battery or other power source (not shown) configured to power the various components within the AR/VR HMD 130, which may include the processing system 310, as mentioned above. In one embodiment, the battery of the AR/VR HMD 130 is a rechargeable battery configured to be charged when the AR/VR HMD 130 is connected to a battery charger configured for use with the AR/VR HMD 130.

The program instructions stored on the memory 314 include the power tool skills training software 120. As discussed in further detail below, the processor 312 is configured to execute the power tool skills training software 120 to control the handheld haptic device 110 and provide AR/VR-based power tool skills training. In one embodiment, the program instructions stored on the memory 314 further include the graphics engine 124 (e.g., Unity3D engine), which is used to render the AR/VR graphical user interface 140 that is displayed on the display screen 330 to provide an augmented or virtual environment for power tool skills training.

### Haptic Vibration Database Creation

To define the vibrotactile feedback that the handheld haptic device 110 should render, the vibrations of various power tools were measured under different operating conditions. In this section, it is detailed how this data was collected. To facilitate easy comprehension, the description will concentrate on a power drill machine as an illustrative example, although a similar approach can be applied to other power tools.

To accurately replicate power tool vibrations through a haptic interface, it is advantageous to capture the vibration data specific to each power tool. This entails the measurement of acceleration, which is then translated into a frequency domain model. A similar process is undertaken for the vibrations of the handheld haptic device 110 generated by the actuators 240A-C. Additionally, a machine learning model is leveraged to establish a mapping between the haptic vibration profiles of physical power tools and the haptic control parameters required to render corresponding haptic feedback using the handheld haptic device 110.

Vibrations can be perceived as the amplitude of physical displacement, which can also be measured in terms of acceleration. To capture the acceleration patterns of a cordless power drill machine, a tri-axial accelerometer was used. The tri-axial accelerometer captured the high-frequency accelerations produced by the power drill machine during various operating states.

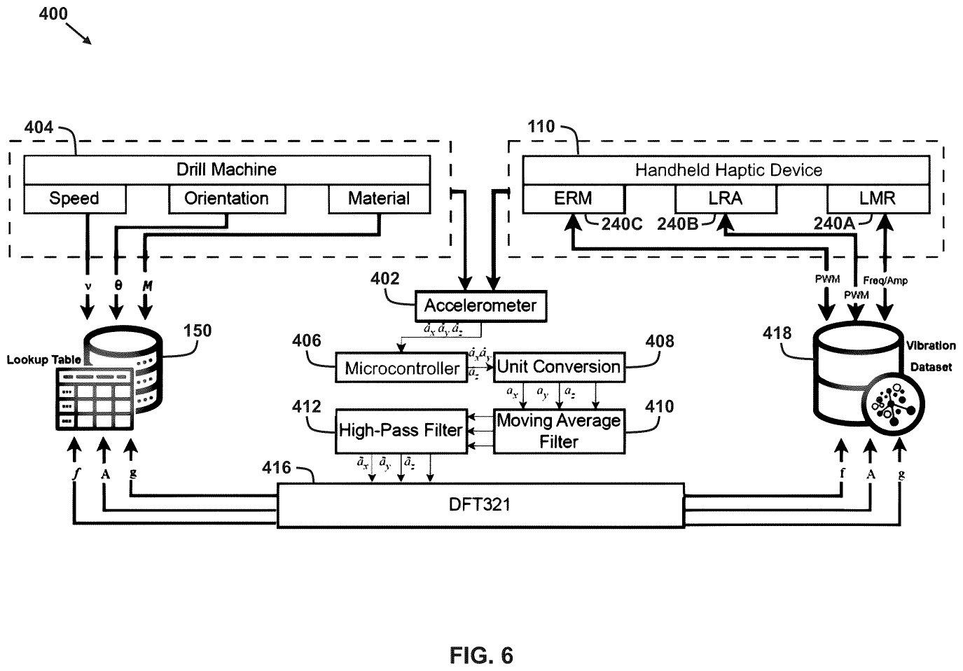

FIG. 6 shows a flowchart for a vibration measurement pipeline 400 used to generate the haptic vibration database 150. In the vibration measurement pipeline 400, an accelerometer 402, which was mounted on a power drill machine 404, outputs three-axis acceleration data [âₓ, â_{y}, â_{z}] as the power drill machine 404 is operated with various operating states. The operating conditions are characterized by a set of state parameters including the operating speed (v) of the power drill machine 404, the orientation (θ) of the power drill machine 404, and the material (M) of a workpiece being worked on by the power drill machine 404. Respective three-axis acceleration data [âₓ, â_{y}, â_{z}] was measured for a plurality of different combinations of values for the state parameters [v, θ, M]. It should be appreciated that each set of values for the state parameters [v, θ, M] will generally result in distinct vibrational feedback from the power drill machine 404. A microcontroller 406 collected the three-axis acceleration data [âₓ, â_{y}, â_{z}] and the data was subsequently stored in a computer (not shown) for post-processing and analysis.

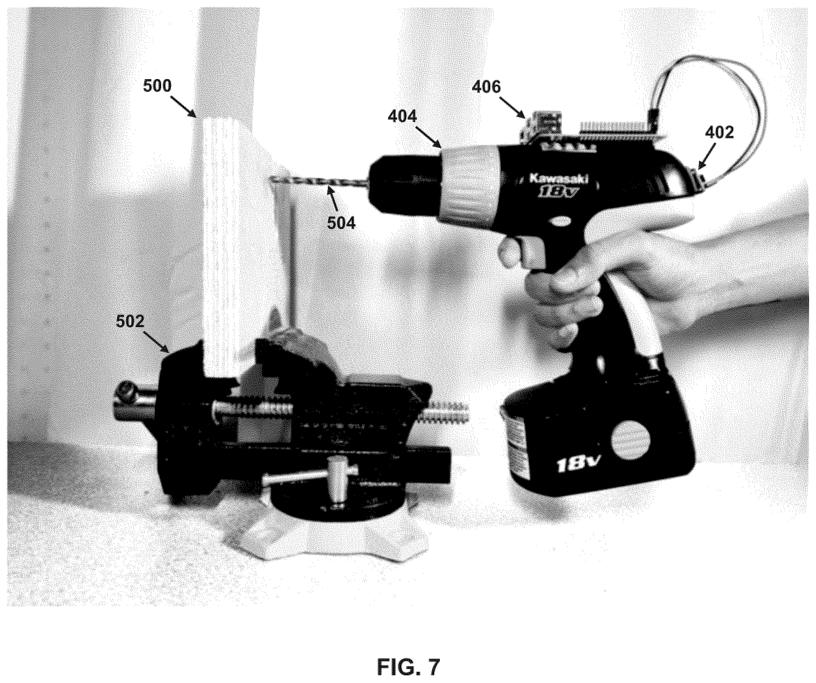

FIG. 7 shows a measurement setup for collecting acceleration data while drilling into a workpiece. In the illustrated example, a wooden workpiece 500 is mounted on a bench vise 502 while drilling is performed by a user using the power drill machine 404 having a drill bit 504. The accelerometer 402 mounted on the back of the power drill machine 404 and connected to the microcontroller 406 using SPI wiring. Vibrations were measured by the accelerometer 402 and the three-axis acceleration data [âₓ, â_{y}, â_{z}] were collected by the microcontroller 406.

Three-axis acceleration data [âₓ, â_{y}, â_{z}] were collected for four different workpiece materials (M) including wood, acrylic, steel, and aluminum. Additionally, three-axis acceleration data [âₓ, â_{y}, â_{z}] were collected for three different operating speeds (v) of the power drill machine 404 including a predetermined low operating speed, a predetermined medium operating speed, and a predetermined high operating speed. Additionally, three-axis acceleration data [âₓ, â_{y}, â_{z}] were collected for three different orientations (θ) of the power drill machine 404 including angle ranges, defined as the deviation angle between the drill bit and the surface normal of the workpiece: ±2°, ±2°-5°, and >5°. Thus, nine measurements were taken for each material (M) of the workpiece, covering various combinations of speed and orientation. The accelerometer's readings were stored as labeled raw data points in the database. Prior to measuring acceleration of the power drill machine 404, the axes of the accelerometer 402 were meticulously calibrated, ensuring accuracy and reliability. During the measurement process, measurements obtained during the calibration phase were subtracted from drilling acceleration values across all three axes.

A user with prior drilling experience executed drilling operations on each sample workpiece 500, adhering to specified parameters. Measurements encompassed all 36 combinations of drilling operations. Each sample's recording spanned 30 seconds, with the first 15 seconds dedicated to aligning the drill gun with the workpiece and ensuring the correct orientation. This initial data was discarded to eliminate vibration resulting from abrupt changes in momentum when the power drill machine is initiated, along with any acceleration linked to tool positioning and initial contact with the workpiece. Data from the subsequent 15 seconds underwent offline processing and was later converted into a frequency domain model to enable haptic rendering.

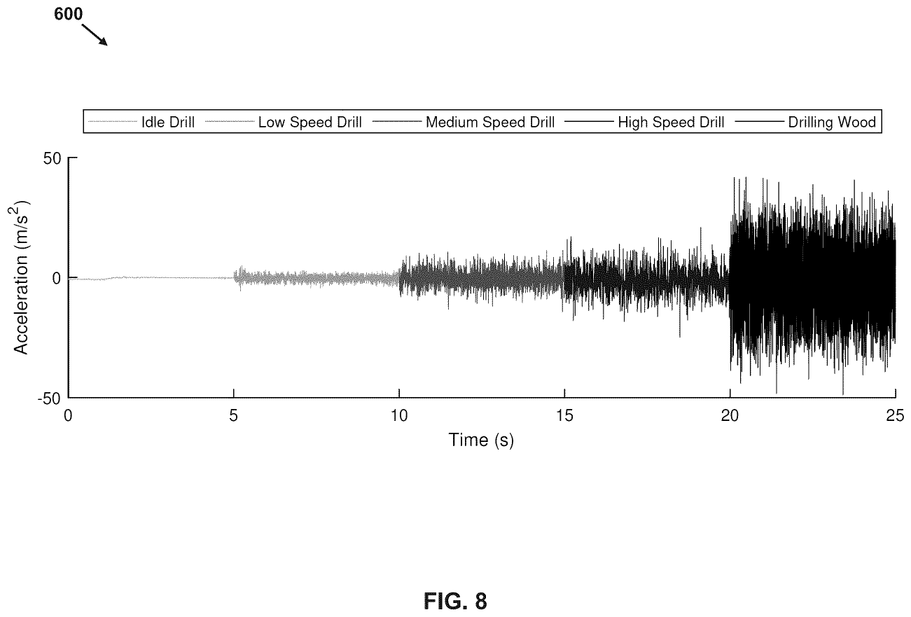

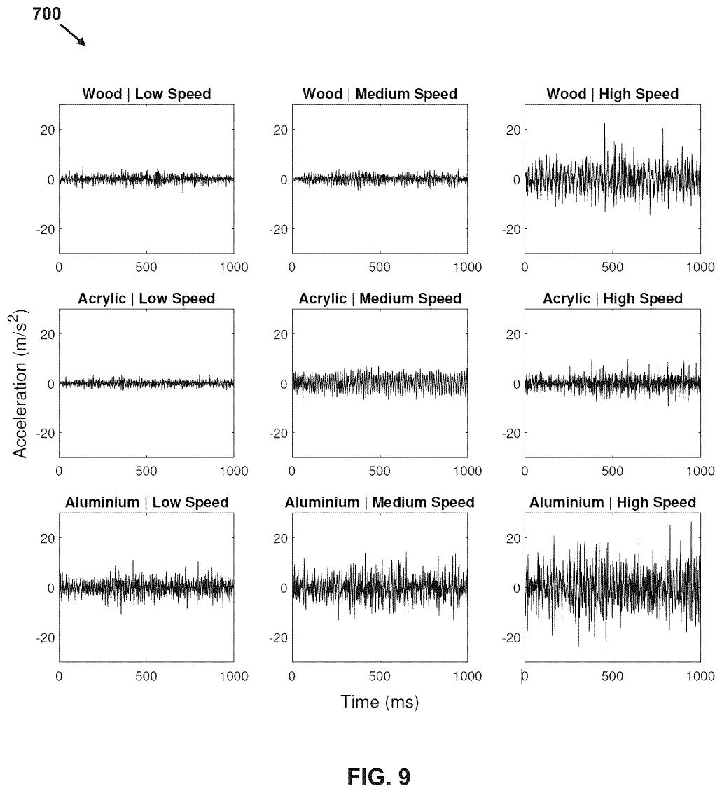

FIG. 8 shows a graph 600 representing power drill acceleration as measured from the accelerometer 402 over time during operation of the power drill machine 404. Particularly, between 0-5 seconds, the power drill machine 404 was in idle operation (trigger was not pressed). Between 5-10 seconds, the power drill machine 404 was operated at a low speed. Between 10-15 seconds, the power drill machine 404 was operated at a medium speed. Between 15-20 seconds, the power drill machine 404 was operated at a high speed. Finally, between 20-25 seconds, the power drill machine 404 was operated at a high speed while drilling into the wooden workpiece 500. Vibration in power tools originates from various sources, including rotating machinery such as motors, gear mechanisms, power transmissions, and the contact of the workpiece with the cutting surface. The vibration experienced by the human hand holding the tool grip dynamically changes based on the user's interaction and control of the tool. Notably, the acceleration patterns change during different operations. For instance, FIG. 8 illustrates the significant variations in vibration while operating the power drill machine 404 at different speeds, as well as the differences observed while drilling through the wooden workpiece 500 at high speed. Similar changes in vibration due to variations in workpiece material are apparent in FIG. 9, discussed below.

FIG. 9 shows several amplitude vs time graphs 700 for vibrations generated while drilling different materials using a power drill as measured from the accelerometer 402. These diverse vibrations provide valuable feedback to power tool users, helping them gauge whether their operations are correct or require adjustments. It is imperative that users become familiar with these vibration patterns during virtual training sessions to facilitate a seamless transition from virtual to physical tool usage. Therefore, using the actuators 240A-C described above, the handheld haptic device 110 is designed to render this wide array of vibrations while accurately tracking user interactions with both the tool and the workpiece within the virtual environment. Importantly, the vibrotactile feedback adapts to changes in operating conditions, such as tool orientation or speed, providing not only different feedback but also realistically replicating the vibratory sensations of using actual power tools. The acceleration patterns vary significantly across materials and speeds, with higher speeds and harder materials producing more pronounced vibrations.

With reference again to FIG. 6, after the raw three-axis acceleration data [âₓ, â_{y}, â_{z}] were collected, the data were post-processed by a computer. Particularly, the units of the raw three-axis acceleration data [âₓ, â_{y}, â_{z}] were converted 408 to arrive at converted three-axis acceleration data [aₓ, a_{y}, a_{z}]. Next, a moving-average filter 410 is applied to the converted three-axis acceleration data [aₓ, a_{y}, a_{z}] to remove the signal noise. Additionally, a high pass filter 412 is applied to remove the gravity components from the accelerometer data (e.g., using a cutoff frequency of 25 Hz). Additionally, given the absence of a rig for hand drill vibration measurement, acceleration values influenced by hand motion and sensor drift were also effectively filtered out using the high pass filter 412. In some embodiments, a low pass filter is also applied (not shown) to eliminate irrelevant machine vibrations for haptic feedback (e.g., using a cutoff frequency of 350 Hz). This consideration aligns with the fact that humans' peak vibration perception occurs in the 200-300 Hz range, and their sensitivity to high-frequency vibrations diminishes as the frequency increases.

Next, frequency spectra of the filtered acceleration data [ã_{y}, ã_{y}, ã_{z}] were determined using Discrete Fourier Transform (DFT). In some embodiments, the filtered acceleration data [ãₓ, ã_{y}, ã_{z}] were reduced to a one-dimensional frequency domain acceleration signal using the Discrete Fourier Transform Three-to-One (DFT321) algorithm 416. The DFT321 algorithm 416 captures spectral and temporal information from filtered acceleration and utilizes frequency domain techniques to merge the three signals. The one-dimensional frequency domain acceleration signal is generated by taking the square root of the sum of squares of all three filtered signals:

$$\vert {Ã}_{s} ( f ) \vert = \sqrt{{\vert {Ã}_{x} ( f ) \vert}^{2} + {\vert {Ã}_{y} ( f ) \vert}^{2} + {\vert {Ã}_{z} ( f ) \vert}^{2}}$$

where Ãₛ(f) is the magnitude of the DFT321 frequency spectrum while the magnitude of the frequency spectrum of the X, Y & Z axis filtered signals are given by Ãₓ(f), Ã_{y}(f) & Ã_{z}(f).

Finally, the acceleration frequency (f), an acceleration amplitude (A), and an acceleration rating (g) of the one-dimensional frequency domain acceleration signal were extracted. The acceleration rating (g) is a representation of the acceleration relative to gravitation acceleration. In each case, the extracted values [f, A, g] were associated with a respective combination of values for the state parameters [v, θ, M] in the haptic vibration database 150 (e.g., in the form of a lookup table). To determine the acceleration amplitude (A), the inverse Discrete Fourier Transform (DFT) was applied to the one-dimensional frequency domain acceleration signal to produce a one-dimensional time-domain acceleration signal. These frequency (f) and amplitude (A) values are stored in a reference table of the haptic vibration database 150 in connection with the power drill machine's speed (v), orientation (θ), and the material (M) properties of the workpiece. In this way, it should be appreciated that the extracted values [f, A, g] constitute the haptic vibration profiles mention previously, which were stored in the haptic vibration database 150 and which can be retrieved as a function of the state parameters [v, θ, M].

### Mapping Haptic Vibration Profiles to Haptics Control Parameters

As previously mentioned, the handheld haptic device 110 is equipped with one or more haptic actuators 240A-C positioned such that it can provide haptic and vibrotactile feedback. Based on current values of the state parameters [v, θ, M], a suitable haptic vibration profile [f, A, g] is selected from haptic vibration database 150. However, in order to accurately reproduce the selected haptic vibration profile [f, A, g] in the handheld haptic device 110 with the actuators 240A-C, the haptic vibration profile must be converted into haptics control parameters for the actuators 240A-C. A mapping function is used to convert the haptic vibration profile [f, A, g] to corresponding haptics control parameters.

With reference again to FIG. 6, the mapping function is learned using a similar process that was described above with respect to creating the haptic vibration database 150. A plurality of combinations of values for the haptics control parameters were sampled and respective raw three-axis acceleration data [âₓ, â_{y}, â_{z}] were measured using the accelerometer 402 as the handheld haptic device 110 was operated with each respective combination of values for the haptics control parameters.

The haptics control parameters include voltages, currents, and frequencies applied to particular actuators 240A-C. In some embodiments, the LMR actuators 240A are configured to be controlled using an API provided by their manufacturer (e.g., Nanoport). This API enables direct input of vibration frequency (Freq_{LMR}) (1-2000 Hz) and intensity (Amp_{LMR}) (0-1). Thus, in some embodiments, the haptics control parameters for the LMR actuators 240A are characterized by frequency and intensity values. In contrast, the LRA motors 240B are configured to be operated using PWM signals (PWM_{LRA}) and can operate within a predetermined voltage range. Similarly, the ERM motors 240C are also configured to be operated using PWM signals (PWM_{ERM}) and can operate within a predetermined voltage range. Thus, in some embodiments, the haptics control parameters for the LRA motors 240B and the ERM motors 240C are characterized by PWM signals (e.g., voltages, currents, duty cycles, frequencies, etc.). It should be appreciated that there are a very large number of possible combinations of values for the haptics control parameters.

With respect to the LMR actuators 240A, measurements were captured by recording data at 10 Hz intervals from 0 to 300 Hz, and 100 Hz intervals from 300 to 2000 Hz—yielding a total of 47 combinations. This data was integrated into a vibration dataset 418 with the input haptics control parameters linked to measured frequencies and amplitudes. Notably, the LMR-generated vibrations exhibited approximately ±15% variance compared to API commands. A combination of hit, pulse, and pause commands can be used to simulate impact and rumble feedback, successfully generating high-g vibrations suitable for power tools such as riveting and impact drivers. Due to the varied possibilities, this data was individually generated to match specific acceleration patterns recorded for pneumatic rivet guns and impact drivers. Two tailored feedback responses were developed for impact-driving screws into wooden and acrylic workpieces, along with four tailored feedback responses for small and large pneumatic rivets, including two for proper riveting and two for incorrect riveting (validated by riveting experts).

For the ERM and LRA motors, vibration measurements were taken individually for each motor, employing a 10% incremental PWM step. Each step lasted 20 seconds, and the accelerations were captured using the accelerometer 402. Additionally, the combined motor vibration measurements were broken down, resulting in a total of 14,640 combinations. This included 600 measurements for pairs of two motors, 4,000 measurements for sets of three motors, and 10,000 measurements for sets of four motors. Out of these 14,600 combinations, 3000 combinations were randomly.

The respective raw three-axis acceleration data [âₓ, â_{y}, â_{z}] measured with respect to each combination of values for the haptics control parameters is post-processed in the same manner as discussed previously with respect to FIG. 6 for generating the haptic vibration database 150. However, the extracted values [f, A, g] are instead associated with a respective combination of values for the haptics control parameters in the vibration dataset 418. Each sample in the vibration dataset 418 includes the input haptics control parameters that were used to operate the actuators 240A-C, a motor index indicating which of the actuators 240A-C were operated, and the corresponding values [f, A, g] extracted from the measured acceleration data [âₓ, â_{y}, â_{z}].

In at least some embodiments, the handheld haptic device 110 utilizes a machine learning model to implement the mapping function that converts a selected haptic vibration profile [f, A, g] to corresponding haptics control parameters. In at least one embodiment, the machine learning model is a K-Nearest Neighbor regression model.

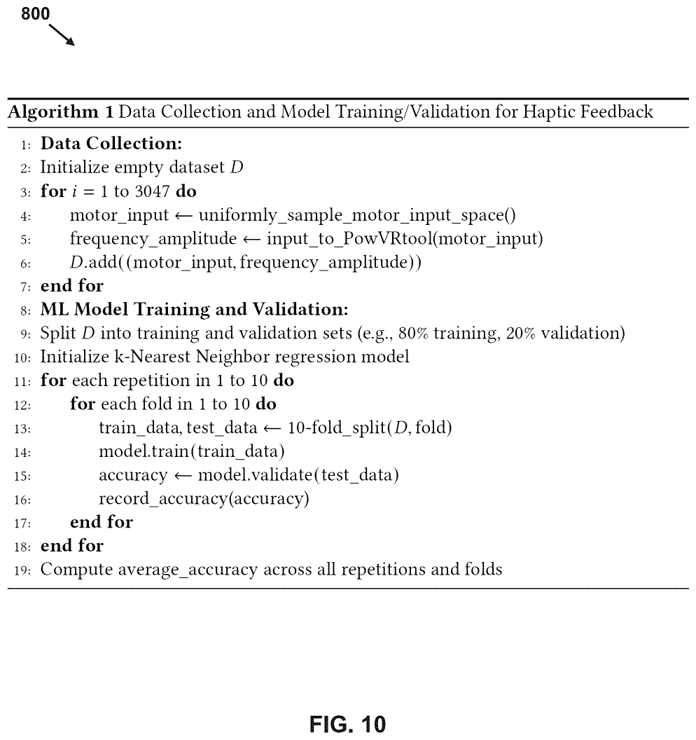

FIG. 10 shows exemplary pseudocode 800 for training a machine learning model for mapping a haptic vibration profile to haptic control parameters for the handheld haptic device 110. In the exemplary pseudocode, the motor input parameter space is uniformly sampled to gather 3047 training samples, which include measurements from individual motors, combinations of two, three, and up to six motors, operated under varying PWM inputs (0-100% duty cycle in 10% steps). Each combination was designed to capture a diverse range of frequency-amplitude responses. Each training sample was fed into the actuators 240A-C of the handheld haptic device 110, with the resulting frequency-amplitude association recorded, forming a training and evaluation dataset. The K-Nearest Neighbor regression model is trained to predict the haptics control parameters (motor inputs) based on the frequency (f)-amplitude (A) associations. Model validation was performed using 10-times-repeated 10-fold cross-validation.

### Methods for Providing Haptic Feedback for Virtual Interactions in AR/VR

A variety of methods, workflows, and processes are described below for enabling the operations and interactions of the AR/VR training system 300. In these descriptions, statements that a method, workflow, processor, and/or system is performing some task or function refers to a controller or processor (e.g., the processor 312) executing programmed instructions (e.g., the power tool skills training software 120) stored in non-transitory computer readable storage media (e.g., the memory 314) operatively connected to the controller or processor to manipulate data or to operate one or more components in AR/VR training system 300 to perform the task or function. Additionally, the steps of the methods may be performed in any feasible chronological order, regardless of the order shown in the figures or the order in which the steps are described.

Additionally, various AR/VR graphical user interfaces are described for operating the AR/VR training system 300. In many cases, AR graphical user interfaces include graphical elements that are superimposed onto the user's view of the outside world or, in the case of a non-transparent display screen 330, superimposed on real-time images/video captured by the camera 332. In order to provide these AR graphical user interfaces, the processor 312 executes instructions of the graphics engine 124 to render these graphical elements and operates the display screen 330 to superimpose the graphical elements onto the user's view of the outside world or onto the real-time images/video of the outside world. In many cases, the graphical elements are rendered at a position that depends upon positional or orientation information received from any suitable combination of the sensors 334 of the AR/VR HMD 130, the camera 332 of the AR/VR HMD 130, and the sensors 252 of the handheld haptic device 110, so as to simulate the presence of the graphical elements in the real-world environment. However, it will be appreciated by those of ordinary skill in the art that, in some cases, an equivalent non-AR/VR graphical user interface can also be used to operate the power tool skills training software 120, such as a user interface provided on a further computing device such as a laptop computer, a tablet computer, a desktop computer, or a smartphone.

Moreover, various user interactions with the AR/VR graphical user interfaces and with interactive graphical elements thereof are described. In order to provide these user interactions, the processor 312 may render interactive graphical elements in the AR graphical user interface, receive user inputs from the user, for example via gestures performed in view of the camera 332 or other sensor, and execute instructions of the power tool skills training software 120 to perform some operation in response to the user inputs.

Finally, various forms of motion tracking are described in which spatial positions and motions of the user or of other objects in the environment are tracked. In order to provide this tracking of spatial positions and motions, the processor 312 executes instructions of the power tool skills training software 120 to receive and process sensor data from any suitable combination of the sensors 334 of the AR/VR HMD 130, the camera 332 of the AR/VR HMD 130, and the sensors 252 of the handheld haptic device 110, and may optionally utilize visual and/or visual-inertial odometry methods such as simultaneous localization and mapping (SLAM) techniques.

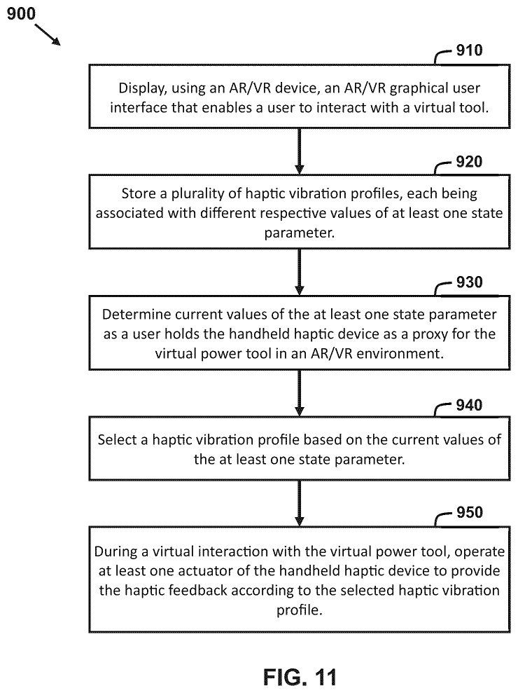

FIG. 11 shows a logical flow diagram for a method 900 for providing haptic feedback for a virtual interaction using a handheld haptic device 110. The method 900 advantageously utilizes haptic vibration profiles that depend on one or more state parameters including, for example, the operating speed of the virtual power tool, the orientation of the virtual power tool, and the material of a workpiece being worked on by the virtual power tool. In this way, the method 900 advantageously provides more realistic haptic and vibrotactile feedback as the user operates a virtual power tool.

The method 900 begins with displaying, using an AR/VR device, an AR/VR graphical user interface that enables a user to interact with a virtual tool (block 910). Particularly, the processor 312 renders and operates the display screen 330 of the AR/VR HMD 130 to display an AR/VR graphical user interface that includes a virtual power tool in an AR or VR environment. As will be discussed in greater detail below, the processor 312 enables virtual interactions with the virtual power tool and renders, within the AR/VR graphical user interface, graphical representations of virtual interactions with the virtual power tool, at least including operating the virtual power tool to perform an operation, such as drilling or sawing, on a virtual workpiece.

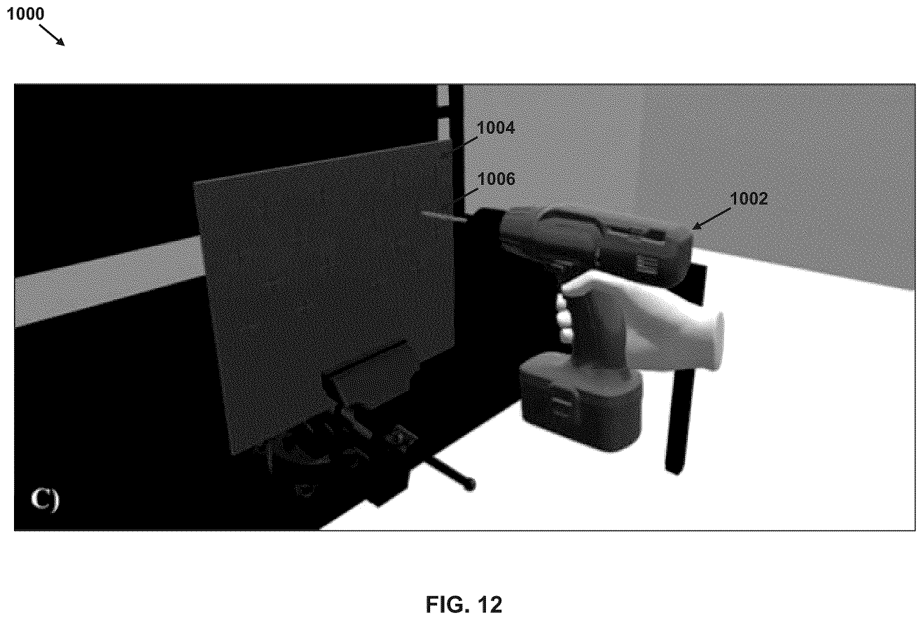

FIG. 12 shows an exemplary AR/VR graphical user interface 1000. As can be seen, the AR/VR graphical user interface 1000 includes a virtual power drill machine 1002. The virtual power drill machine 1002 can be manipulated and operated by the user to perform a drilling operation on a virtual workpiece 1004. However, it should be appreciated that a variety of other virtual power tools can be provided within the AR/VR graphical user interface 1000 that can be virtually interacted with to perform a variety of other virtual interactions.

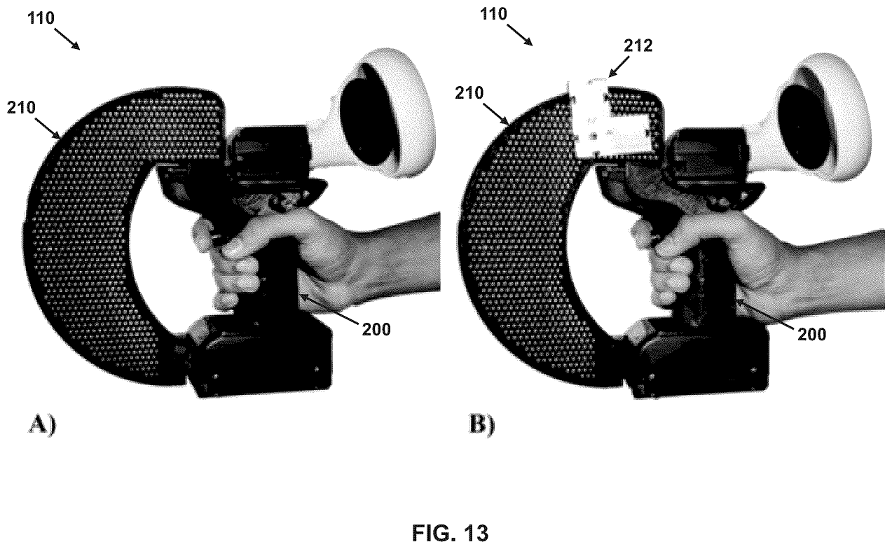

FIG. 13 shows a user holding the handheld haptic device 110. Particularly, while interacting with the AR/VR graphical user interface, the user holds the handheld haptic device 110 as a physical proxy for the virtual power tool (e.g., virtual power drill machine 1002), as shown in illustration A) of FIG. 13. Prior to interacting with the virtual power tool in the AR/VR graphical user interface, the user attaches one or more of the detachable weights 212 to the weight shift linkage 210 at a location on the weight shift linkage 210 such that a center of gravity of the handheld haptic device 110 relative to the handle 200 matches a center of gravity of a physical power tool relative to a handle of the physical power tool that corresponds to the virtual power tool. In the example of FIG. 12, the virtual power drill machine 1002 corresponds to a physical power drill machine. It should be appreciated that a physical power drill machine is often top-heavy, due to its motor residing above the handle. To passively simulate the feeling of holding a physical power drill machine, the detachable weights 212 are attached to the weight shift linkage 210 at a location that is above the handle 200, as shown in illustration B) of FIG. 13, which shifts the center of gravity of the handheld haptic device 110 to mimic that of a physical power drill machine.

In at least some embodiments, as the user holds and manipulates the handheld haptic device 110, the processor 312 tracks a pose (i.e., position and orientation) of the handheld haptic device 110 an environment over time. In particular, in some embodiments, the sensors 252 of the handheld haptic device 110 measure a positions and/or orientations (θ) of the handheld haptic device 110 over time. As described above, the sensors 252 may include accelerometers and/or gyroscopic sensors integrated into the handheld haptic device 110. The communications module 262 of the handheld haptic device 110 transmits the measured positions and/or orientations (θ) to the AR/VR training system 300. Alternatively, the processor 312 operates the camera 332 to capture images of the handheld haptic device 110 and determines the positions and/or orientations (θ) of the handheld haptic device 110 over time using a vision-based object-tracking algorithm and/or pose-estimation algorithm.

The processor 312 operates the display screen 330 to display, in the AR/VR graphical user interface, the graphical representation of the virtual power tool having a pose within the AR/VR environment that is based on the tracked pose of the handheld haptic device 110. In this way, the graphical representation of the virtual interactions with the virtual power tool mirror the physical interactions between the hand of the user and the handheld haptic device 110.

The method 900 continues with storing a plurality of haptic vibration profiles, each being associated with different respective values of at least one state parameter (block 920). Particularly, the AR/VR training system 300 stores, in the memory 314, the haptic vibration database 150 including a plurality of haptic vibration profiles. As discussed previously, each respective haptic vibration profile is associated with different respective values of at least one state parameter. More particularly, each haptic vibration profile is associated with values of a set of state parameters including the operating speed (v) of the virtual power tool (e.g., the virtual power drill machine 1002), the orientation (θ) of the handheld haptic device 110 (or equivalently, the orientation of the virtual power tool), and the material (M) of the virtual workpiece (e.g., virtual workpiece 1004) being operated on by the virtual power tool.

As discussed in greater detail previously, to enhance the realism of the handheld haptic device 110 as a physical proxy for the virtual power tool, the plurality of haptic vibration profiles were generated by recording vibrations of a physical power tool corresponding to the virtual power tool under operating conditions corresponding to the different respective values of the state parameters [v, θ, M].

The method 900 continues with determining current values of the at least one state parameter as a user holds the handheld haptic device as a proxy for a virtual power tool in an AR/VR environment (block 930). Particularly, the processor 312 determines current values of the state parameters [v, θ, M] as a user holds and manipulates the handheld haptic device 110 to interact with virtual power tool within the AR/VR environment. As mentioned above, as the user holds and manipulates the handheld haptic device 110, the processor 312 tracks a pose (i.e., position and orientation) of the handheld haptic device 110 in the environment over time. Based on this pose tracking, the current value of the orientation (θ) of the handheld haptic device 110 is known. Additionally, the material (M) of the virtual workpiece (e.g., the virtual workpiece 1004) is provided directly from the graphics engine 124 and/or the power tool skills training software 120

As discussed previously, the handheld haptic device 110 includes a trigger 204 or other input device via which the user can interact with the handheld haptic device 110 in a tactile manner. The trigger 204 is actuated by the user to provide a control input parameter that dictates the operating speed (v) of the virtual power tool. Particularly, the controller 260 receives the control input parameter (e.g., corresponding to an actuation position of the trigger 204) from the trigger 204. The communications module 262 transmits the control input parameter to the AR/VR training system 300. The processor 312 sets the current value of the operating speed (v) of the virtual power tool based on the control input parameter received from the handheld haptic device 110.

The method 900 continues with selecting a haptic vibration profile based on the current values of the at least one state parameter (block 940). Particularly, the processor 312 selects a haptic vibration profile from the plurality of haptic vibration profiles in the haptic vibration database 150 based on the current values of the state parameters [v, θ, M]. The processor 312 selects a haptic vibration profile that based on the current operating speed (v) of the virtual power tool (which was set based on the control input parameter received from the handheld haptic device 110), based on the current orientation (θ) of handheld haptic device 110, and based on the material (M) of the virtual workpiece.

The method 900 continues with, during a virtual interaction with the virtual power tool, operating at least one actuator of the handheld haptic device to provide haptic feedback according to the selected haptic vibration profile (block 950). Particularly, as the user virtually interacts with the virtual power tool in within the AR/VR environment, the controller 260 commands the motor driver 264 to operate the actuators 240A-C of the handheld haptic device 110 to provide haptic feedback according to the selected haptic vibration profile. The actuators 240A-C include one or more of LMR actuators 240A, LRA motors 240B, or ERM motors 240C, which are integrated into the housing 230 of the handheld haptic device 110.

As discussed previously, in at least some embodiments, the haptic vibration profile takes the form of an acceleration frequency (f), an acceleration amplitude (A), and, in some cases, also an acceleration rating (g), that define a one-dimensional frequency domain acceleration signal. The processor 312 maps the selected haptic vibration profile [f, A, g] to haptic control parameters designed to operate the actuators 240A-C in a manner so as to reproduce the selected haptic vibration profile in the handheld haptic device 110. More particularly, based on the values [f, A, g], the processor 312 determines one or more of the actuators 240A-C that should be operated, e.g., motor indices indicating which of the actuators 240A-C should be operated. Additionally, based on the values [f, A, g], the processor 312 determines haptic control parameters for operating the actuators 240A-C, including voltages, currents, and frequencies to be applied to particular actuators 240A-C. In at least some embodiments, the processor 312 maps the selected haptic vibration profile [f, A, g] to haptic control parameters using a machine learning model, such as a K-Nearest Neighbor regression model.

Once haptic control parameters are determined, the processor 312 operates a transceiver, such as the Wi-Fi module 316 to transmit the haptic control parameters to the handheld haptic device 110. The communications module 262 of the handheld haptic device 110 receives the haptic control parameters and provides them to the controller 260. The controller 260 commands the motor driver 264 to operate the actuators 240A-C of the handheld haptic device 110 to provide haptic feedback according to the selected haptic vibration profile

Concurrently with operating the actuators 240A-C to provide haptic feedback according to the selected haptic vibration profile, the processor 312 operates the display screen 330 to display, within the AR/VR graphical user interface, an animation of the virtual power tool performing an operation based on the current operating speed (v) of the virtual power tool (which was set based on the control input parameter received from the handheld haptic device 110). With reference again to the exemplary AR/VR graphical user interface 1000 of FIG. 12, in response to the user actuating the trigger 204 of the handheld haptic device 110, the virtual power drill machine 1002 is animated to show the drill bit 1006 rotating at a speed corresponding to the current operating speed (v). Additionally, in response to the user positioning the handheld haptic device 110 within the real-world environment at a position that causes the virtual power drill machine 1002 to come into virtual contact with the virtual workpiece 1004, the virtual power drill machine 1002 is animated to show the drill bit 1006 drilling into the virtual workpiece 1004.

In this way, as the user virtually interacts with the virtual power tool, the AR/VR training system 300 provides both a visual representation and the physical haptic sensations of the virtual interaction, thereby greatly enhancing the immersion and realism of the power tool skills training software 120.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for providing haptic feedback for a virtual interaction using a handheld haptic device, the virtual interaction including operating a virtual power tool, the method comprising:
storing, in a memory, a plurality of haptic vibration profiles, each respective haptic vibration profile being associated with different respective values of at least one state parameter;
determining current values of the at least one state parameter as a user holds the handheld haptic device;
selecting, from the plurality of haptic vibration profiles, a selected haptic vibration profile based on the current values of the at least one state parameter; and
operating, during the virtual interaction, at least one actuator of the handheld haptic device to provide the haptic feedback according to the selected haptic vibration profile.

2. The method according to claim 1, wherein the virtual interaction includes controlling the virtual power tool to perform an operation on a virtual workpiece, the method further comprising:
receiving a material parameter indicating a material of the virtual workpiece, the at least one state parameter including the material parameter; and
selecting the selected haptic vibration profile based on the material parameter.

3. The method according to claim 1, wherein the handheld haptic device includes an input device configured to provide a control input parameter depending on an actuation of the input device by a user, the method further comprising:
receiving a current value of the control input parameter from the input device, the at least one state parameter including the control input parameter; and
selecting the selected haptic vibration profile based on the current value of the control input parameter.

4. The method according to claim 1 further comprising:
determining a current value of an orientation parameter indicating an orientation of the handheld haptic device, the at least one state parameter including the orientation parameter; and
selecting the selected haptic vibration profile based on the current value of the orientation parameter.

5. The method according to claim 4, the determining the current value of the orientation parameter further comprising:
measuring the orientation of the handheld haptic device with a gyroscopic sensor that is integrated into the handheld haptic device.

6. The method according to claim 4, the determining the current value of the orientation parameter further comprising:
capturing images of the handheld haptic device with a camera; and
determining the orientation of the handheld haptic device based on the images using a pose-estimation algorithm.

7. The method according to claim 1, the operating the at least one actuator of the handheld haptic device further comprising:
mapping the selected haptic vibration profile to haptic control parameters configured to operate the at least one actuator to reproduce the selected haptic vibration profile in the handheld haptic device.

8. The method according to claim 7, the mapping further comprising:
mapping the selected haptic vibration profile to the haptic control parameters using a machine learning model.

9. The method according to claim 7, wherein each haptic vibration profile of the plurality of haptic vibration profiles includes an acceleration frequency and an acceleration amplitude.

10. The method according to claim 7, wherein the at least one actuator of the handheld haptic device includes a plurality of actuators, the plurality of actuators being arranged at different locations in the handheld haptic device and including multiple different types of actuators.

11. The method according to claim 10, the mapping further comprising:
determining which actuators of the plurality of actuators are to be operated to reproduce the selected haptic vibration profile in the handheld haptic device.

12. The method according to claim 7, wherein the haptic control parameters include at least one of voltages, currents, or frequencies used to operate the at least one actuator to reproduce the selected haptic vibration profile in the handheld haptic device.

13. The method according to claim 7, the operating the at least one actuator of the handheld haptic device further comprising:
transmitting, with a transceiver, the haptic control parameters to the handheld haptic device; and
operating the at least one actuator based on the haptic control parameters using a controller of the handheld haptic device.

14. The method according to claim 1, wherein the at least one actuator of the handheld haptic device includes at least one of a linear resonant actuator, an eccentric rotating mass motor, or linear magnetic ram.

15. The method according to claim 1, wherein the handheld haptic device includes (i) a handle configured to be grasped by a user and (ii) a support structure extending from the handle configured to detachably connect with at least one detachable weight, the method further comprising:
attaching, prior to the virtual interaction, the at least one detachable weight to the support structure at a location on the support structure such that a center of gravity of the handheld haptic device relative to the handle of the handheld haptic device matches a center of gravity of a physical power tool relative to a handle of the physical power tool, the physical power tool corresponding to the virtual power tool.

16. The method according to claim 15, wherein (i) the at least one detachable weight includes a pair of detachable weights having a same mass and (ii) the support structure has a substantially planar first surface configured to detachably connect with a first detachable weight of the pair of detachable weights and a substantially planar second surface, opposite the substantially planar first surface, configured to detachably connect with a second detachable weight of the pair of detachable weights.

17. The method according to claim 1, wherein the plurality of haptic vibration profiles was generated by recording vibrations of a physical power tool corresponding to the virtual power tool under operating conditions corresponding to the different respective values of the at least one state parameter.

18. The method according to claim 1 further comprising:
tracking a pose of the handheld haptic device in an environment over time; and
displaying, in an augmented reality or virtual reality graphical user interface on a display screen, a graphical representation of the virtual interaction including rendering the virtual power tool having the pose of the handheld haptic device.

19. The method according to claim 18, wherein the handheld haptic device includes an input device configured to output a control input parameter depending on an actuation of the input device by a user, the method further comprising:
receiving a current value of the control input parameter from the input device; and
displaying, concurrently with the operating the at least one actuator of the handheld haptic device, in the augmented reality or virtual reality graphical user interface, an animation of the virtual power tool performing an operation based on the current value of the control input parameter.

20. A system for providing haptic feedback for a virtual interaction, the virtual interaction including operating a virtual power tool, the system comprising:
an augmented reality or virtual reality device including (i) a processor, (ii) a memory that stores a plurality of haptic vibration profiles, each respective haptic vibration profile being associated with different respective values of at least one state parameter, and (iii) a display screen configured to display an augmented reality or virtual reality graphical user interface including a graphical representation of the virtual interaction; and
a handheld haptic device having at least one actuator arranged within a housing,
wherein the processor of the augmented reality or virtual reality device is configured to (i) determine current values of the at least one state parameter as a user holds the handheld haptic device, (ii) select, from the plurality of haptic vibration profiles, a selected haptic vibration profile based on the current values of the at least one state parameter, and (iii) operate, during the virtual interaction, the at least one actuator of the handheld haptic device to provide the haptic feedback according to the selected haptic vibration profile.
